(19) United States
(12) Patent Application Publication
(10) Pub. No.: US 2024/0266559 A1
(43) Pub. Date: Aug. 8, 2024

(54) VEHICLE

(71) Applicant: TOYOTA JIDOSHA KABUSHIKI KAISHA, Toyota-shi (JP)

(72) Inventors: Tomoyuki KISHIDA, Nisshin-shi (JP); Kunihiro WASHINO, Nagoya-shi (JP); Osamu SAWAI, Okazaki-shi (JP)

(73) Assignee: TOYOTA JIDOSHA KABUSHIKI KAISHA, Toyota-shi (JP)

(21) Appl. No.: 18/537,979

(22) Filed: Dec. 13, 2023

(30) Foreign Application Priority Data
Feb. 7, 2023 (JP) 2023-016935

(51) Int. Cl. H01M 8/04029; B60L 58/33; H01M 8/04089; H01M 8/2484

(52) U.S. Cl. CPC H01M 8/04029; B60L 58/33; H01M 8/04089; H01M 8/2484; H01M 2250/20

(57) ABSTRACT

A vehicle including a fuel cell stack, a radiator for cooling coolant circulated in the fuel cell stack, a plurality of gas tanks filled with hydrogen to be supplied to the fuel cell stack, a manifold connecting openings of the plurality of gas tanks, and a cooling channel provided in the manifold for circulating coolant.

### CROSS-REFERENCE TO RELATED APPLICATION

This application claims priority to Japanese Patent Application No. 2023-016935 filed on Feb. 7, 2023, incorporated herein by reference in its entirety.

### BACKGROUND

### 1. Technical Field

The present disclosure relates to a vehicle.

### 2. Description of Related Art

Japanese Unexamined Patent Application Publication No. 2007-056891 (JP 2007-056891 A) describes a vehicle including a fuel cell system that includes a hydrogen gas tank storing high-pressure hydrogen gas and generates electric power through an electrochemical reaction between hydrogen and oxygen.

### SUMMARY

In vehicles such as sport utility vehicles (SUVs) and trailers including fuel cell stacks, a load on the fuel cell stack increases and the temperature of a coolant tends to rise during high-load travel such as towing travel or towing uphill. In order to ensure the performance of a radiator that cools the coolant and suppress the temperature rise of the coolant, it is necessary to increase the size of the radiator. When the size of the radiator is increased, however, it is difficult to fit the radiator into a vehicle body, and restrictions on vehicle design increase, which increases the cost of the vehicle.

The present disclosure provides a vehicle including a fuel cell stack in which an increase in the size of a radiator can be suppressed while suppressing a temperature rise of a coolant during high-load travel of the vehicle.

One aspect of the present disclosure provides a vehicle. The vehicle includes: a fuel cell stack; a radiator configured to cool a coolant circulating in the fuel cell stack; a plurality of gas tanks filled with hydrogen to be supplied to the fuel cell stack; a manifold connecting openings of the gas tanks; and a cooling channel that is provided in the manifold and through which the coolant circulates.

According to the above aspect of the present disclosure, it is possible to provide the vehicle including the fuel cell stack in which the increase in the size of the radiator can be suppressed while suppressing the temperature rise of the coolant during the high-load travel of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of multiple gas tanks showing an embodiment of a vehicle according to the present disclosure;

FIG. 2 is a schematic diagram showing coolant flow in a vehicle according to the present disclosure; and

FIG. 3 is a cross-sectional view of a connecting portion of a manifold to which the gas tank of FIG. 1 is connected.

### DETAILED DESCRIPTION OF EMBODIMENTS

Hereinafter, embodiments of a vehicle according to the present disclosure will be described with reference to the drawings.

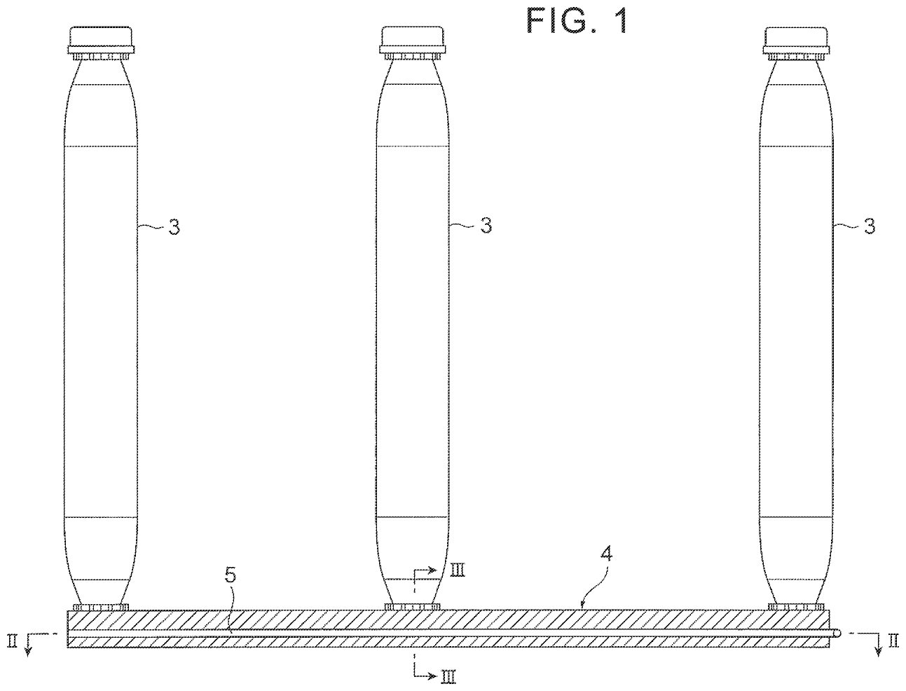

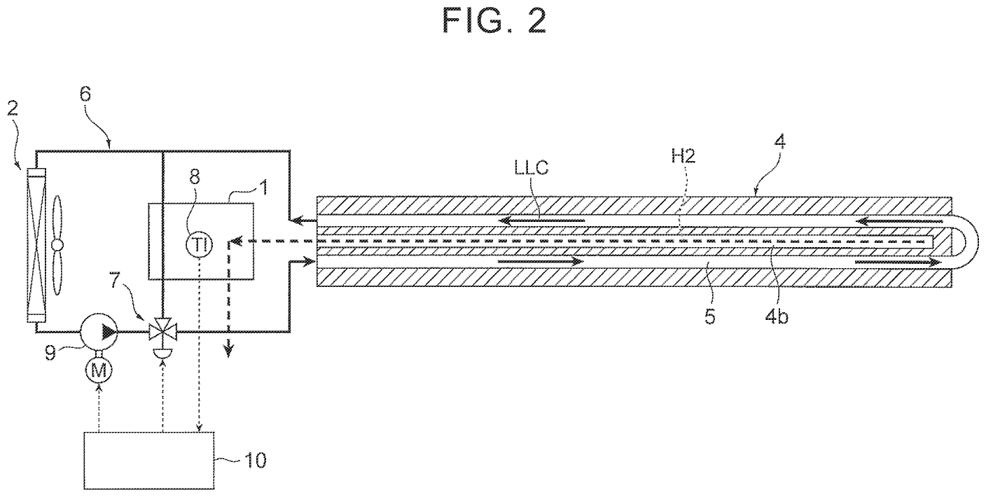

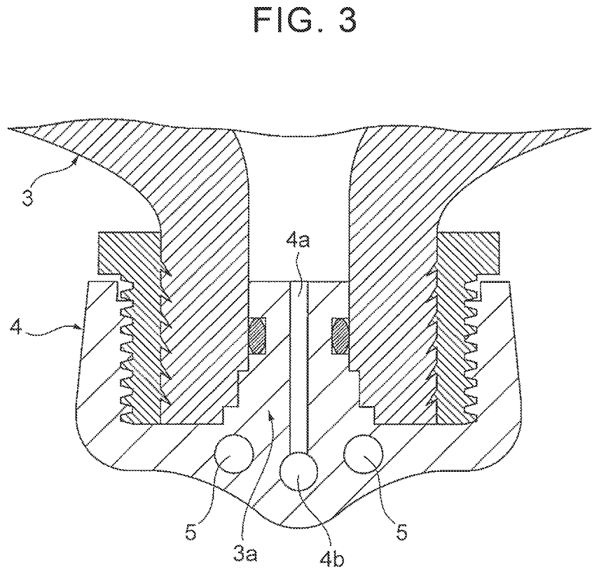

FIG. 1 is a side view of multiple gas tanks 3 showing an embodiment of a vehicle according to the present disclosure. FIG. 2 is a schematic diagram showing the flow of coolant LLC in the vehicle of this embodiment. FIG. 3 is a cross-sectional view of a connecting portion of the manifold 4 to which each of the plurality of gas tanks 3 of FIG. 1 is connected, and is a cross-sectional view taken along line III-III of FIG. 1. The cross section of the manifold 4 shown in FIG. 2 corresponds to the cross section along line II-II in FIG. 1.

The vehicle of this embodiment is, for example, a fuel cell electric vehicle equipped with a fuel cell system including the fuel cell stack 1. The vehicle of the present embodiment is, for example, a sport utility vehicle (SUV), a trailer, or other vehicle that is assumed to perform high-load driving including towing driving and towing uphill driving. When the vehicle is running under a high load, the load on the fuel cell stack 1 is higher than when the vehicle is running normally, and the temperature of the coolant LLC that cools the fuel cell stack 1 tends to rise.

The vehicle of this embodiment includes, for example, a fuel cell stack 1, a radiator 2, a plurality of gas tanks 3, a manifold 4, and a cooling channel 5. Further, the vehicle of this embodiment may include, for example, the circulation channel 6, the control valve 7, the temperature sensor 8, the electric water pump 9, and the control device 10.

The fuel cell stack 1 generates electricity by reacting hydrogen H2 supplied from a plurality of gas tanks 3 through a manifold 4 with oxygen contained in air supplied through an air passage (not shown). The radiator 2 cools the coolant LLC circulated through the fuel cell stack 1. A plurality of gas tanks 3 are each filled with high-pressure hydrogen H2 to be supplied to the fuel cell stack 1.

The manifold 4 connects the openings 3a of the plurality of gas tanks 3, as shown in FIG. 3. The manifold 4 has, for example, a plurality of connecting portions that connect the openings 3a of the gas tanks 3, respectively. Each connecting portion of the manifold 4 has, for example, a communication passage 4a that communicates with the internal space of the gas tank 3. Further, the manifold 4 has gas channels 4b that communicate with the plurality of communication passages 4a.

The gas channel 4b extends through the manifold 4 in the longitudinal direction, for example, from an opening provided at one longitudinal end of the manifold 4 to a communication passage 4a at the other longitudinal end of the manifold 4. It is provided inside the manifold 4 as shown. Hydrogen H2 filled in a plurality of gas tanks 3 connected to a plurality of connecting portions of the manifold 4 flows into the gas channel 4b through the communication passage 4a of each connecting portion, and flows through the gas channel 4b into fuel. It is supplied to the fuel cell stack 1.

The cooling channel 5 is provided in the manifold 4 and allows the coolant LLC to flow. The cooling channels 5 are provided, for example, through the manifold 4 in the longitudinal direction on both sides of a gas channel 4b extending from one longitudinal end to the other end of the manifold 4. The cooling channel 5 is provided inside the manifold 4 over the entire length of the gas channel 4b so as to reciprocate between one end and the other end of the manifold 4 in the longitudinal direction. The cooling channel 5 does not necessarily have to be provided inside the manifold 4, and for example, may be provided adjacent to the outside of the manifold 4 while being in contact with the manifold 4 so as to allow heat conduction.

The cooling channel 5 has, for example, an inlet and an outlet, an outward path and a return path, and a folded portion. The inlet and outlet of the cooling channel 5 are open on both sides of the opening of the gas channel 4b provided at one end of the manifold 4 in the longitudinal direction. The outward path of the cooling channel 5 extends through the manifold 4 in the longitudinal direction from the inlet of the cooling channel 5 that opens at one end in the longitudinal direction of the manifold 4 to the other end in the longitudinal direction of the manifold 4, and is provided along the gas channel 4b.

The return path of the cooling channel 5 extends through the manifold 4 in the longitudinal direction from the other end of the manifold 4 opposite to the one longitudinal end of the manifold 4 where the outlet of the cooling channel 5 is provided to the outlet of the cooling channel 5, and is provided along the gas channel 4b. The turn-back portion of the cooling channel 5 connects the outward and return paths of the cooling channel 5 with the one longitudinal end of the manifold 4 where the inlet and outlet of the cooling channel 5 are provided, and the other longitudinal end of the manifold 4 on the opposite side.

The circulation channel 6 circulates the coolant LLC through the fuel cell stack 1, the radiator 2, and the cooling channel 5, for example. Also, the circulation channel 6 may have a bypass flow path between the fuel cell stack 1 and the manifold 4 for adjusting pressure loss, for example.

Control valve 7 is provided, for example, in circulation channel 6. Control valve 7 adjusts, for example, the flow rate of coolant LLC flowing through fuel cell stack 1 and the flow rate of coolant LLC flowing through cooling channel 5. Control valve 7 is, for example, a three-way valve provided at a branch of circulation channel 6. By controlling the opening degree of the control valve 7, the flow rate of the coolant LLC flowing into the cooling channel 5 of the manifold 4 and the flow rate of the coolant LLC flowing into the fuel cell stack 1 can be controlled. In addition, the control valve 7 is not limited to a three-way valve, and may be a flow control valve provided in the circulation channel 6.

Temperature sensor 8 detects, for example, the temperature of fuel cell stack 1 and outputs the detected temperature to control device 10. The electric water pump 9 is provided, for example, in the circulation channel 6 and pumps the coolant LLC to circulate in the circulation channel 6. The control device 10 feedback-controls the opening degree of the control valve 7 based on the temperature of the fuel cell stack 1 detected by the temperature sensor 8. Further, the control device 10 may control the discharge flow rate of the electric water pump 9 provided in the circulation channel 6 based on the temperature of the fuel cell stack 1 detected by the temperature sensor 8, for example.

The operation of the vehicle of this embodiment shown in FIGS. 1 to 3 will be described below.

As described above, the vehicle of this embodiment is filled with the fuel cell stack 1, the radiator 2 that cools the coolant LLC circulating in the fuel cell stack 1, and the hydrogen H2 that is supplied to the fuel cell stack 1. A plurality of gas tanks 3 are provided. The vehicle of this embodiment also includes a manifold 4 that connects the openings 3a of the plurality of gas tanks 3, and a cooling channel 5 that is provided in the manifold 4 and circulates the coolant LLC.

With such a configuration, the vehicle of the present embodiment, for example, during high load running including towing running and towing uphill running, the load on the fuel cell stack 1 becomes higher than during normal running, and the temperature of the coolant LLC becomes easier to rise. However, when the vehicle is running under high load, the flow rate of hydrogen H2 supplied from the plurality of gas tanks 3 to the fuel cell stack 1 increases.

As a result, the amount of high-pressure hydrogen H2 released from each gas tank 3 increases, and the amount of hydrogen H2 that expands adiabatically in the process of passing through the manifold 4 connecting the openings 3a of each gas tank 3 increases. As a result, the temperature of the manifold 4 is lower than that during normal running of the vehicle, and the coolant LLC flowing through the cooling channel 5 is cooled by the manifold 4 whose temperature is lowered.

That is, when the vehicle is running under high load, the fuel cell stack 1 is cooled and the coolant LLC whose temperature is higher than that during normal running is circulated through the cooling channel 5 to be able to cool the coolant LLC not only in the radiator 2 but also in the manifold 4. Therefore, according to the vehicle of the present embodiment, it is possible to suppress the temperature rise of the coolant LLC when the vehicle equipped with the fuel cell stack 1 is running under high load. Therefore, it is possible to suppress an increase in the size of the radiator 2, improve the flexibility of the vehicle body space and vehicle design, and reduce the cost.

Moreover, the vehicle of this embodiment further includes a control valve 7. The control valve 7 is provided in the fuel cell stack 1, the radiator 2, and the circulation channel 6 that circulates the coolant LLC through the cooling channel 5. The control valve 7 adjusts the flow rate of the coolant LLC flowing through the fuel cell stack 1 and the flow rate of the coolant LLC flowing through the cooling channel 5.

With such a configuration, according to the vehicle of the present embodiment, for example, when the vehicle is running under a high load, the control valve 7 can increase the flow rate of the coolant LLC flowing through the cooling channel 5 more than during normal running. As a result, the coolant LLC, whose temperature has risen more than that during normal running by cooling the high-load fuel cell stack 1, can be efficiently cooled by the manifold 4 whose temperature has decreased compared to that during normal running.

Further, the vehicle of this embodiment further includes a control device 10 that performs feedback control of the opening of the control valve 7 based on the temperature sensor 8 that detects the temperature of the fuel cell stack 1 and the temperature of the fuel cell stack 1 detected by the temperature sensor 8.

With such a configuration, for example, when the detected temperature of the fuel cell stack 1 exceeds the target temperature, the control device 10 controls the opening of the control valve 7 based on the difference between the detected temperature and the target temperature, and the flow rate of the coolant LLC flowing through the cooling channel 5 can be increased. As a result, the coolant LLC, whose temperature has risen more than that during normal running by cooling the high-load fuel cell stack 1, can be efficiently cooled by the manifold 4 whose temperature has decreased compared to that during normal running.

As described above, according to the present embodiment, the vehicle equipped with the fuel cell stack 1 is capable of suppressing an increase in the temperature of the coolant LLC during high-load running, and a vehicle that can suppress an increase in the size of the radiator 2 can be provided.

As described above, the embodiment of the vehicle according to the present disclosure has been described in detail with reference to the drawings, but the specific configuration is not limited to this embodiment, and design changes and the like can be made without departing from the gist of the present disclosure. If so, they are intended to be included in this disclosure.

What is claimed is:

1. A vehicle comprising:
a fuel cell stack;
a radiator configured to cool a coolant circulating in the fuel cell stack;
a plurality of gas tanks filled with hydrogen to be supplied to the fuel cell stack;
a manifold connecting openings of the gas tanks; and
a cooling channel that is provided in the manifold and through which the coolant circulates.

2. The vehicle according to claim 1, further comprising a control valve that is provided in a circulation channel for circulation of the coolant through the fuel cell stack, the radiator, and the cooling channel and that is configured to adjust a flow rate of the coolant flowing through the fuel cell stack and a flow rate of the coolant flowing through the cooling channel.

3. The vehicle according to claim 2, further comprising:
a temperature sensor configured to detect a temperature of the fuel cell stack; and
a control device configured to perform feedback control on an opening degree of the control valve based on the temperature of the fuel cell stack that is detected by the temperature sensor.
